(19) United States
(12) Patent Application Publication
(10) Pub. No.: US 2018/0011741 A1
(43) Pub. Date: Jan. 11, 2018

(54) INTEROPERABILITY-AS-A-SERVICE IN A CLOUD ENVIRONMENT

(71) Applicant: HEWLETT PACKARD ENTERPRISE DEVELOPMENT LP, Houston, TX (US)

(72) Inventors: Swaroop Jayanthi, Bangalore (IN); Sripadwallabha Dattatraya Kollur, Bangalore (IN); Brahmanand Vuppuluri, Bangalore (IN); Kanagaraj Manickam, Bangalore (IN)

(21) Appl. No.: 15/543,130

(22) PCT Filed: Jun. 30, 2015
(86) PCT No.: PCT/US15/38499

§ 371 Date: Jul. 12, 2017

(30) Foreign Application Priority Data
Apr. 10, 2015 (IN) 1897/CHE/2015

(51) Int. Cl. G06F 9/50; G06F 9/54; G06F 9/455

(52) U.S. Cl. CPC G06F 9/5011; G06F 9/547; G06F 9/45558; G06F 2009/45591

(57) ABSTRACT

Methods, devices, and techniques for determining interoperable resources are discussed herein. For example, in one aspect, a resource in a cloud environment may be discovered. Responsive to discovering the resource, an interoperability support matrix associated with the resource can be obtained. The interoperability support matrix may specify another resource that interoperates with the resource. An interoperability record is then stored in an interoperability support matrix repository. The interoperability record can specify that the another resource interoperates with the resource.

### BACKGROUND

A cloud environment can include different types of resources, such as hardware resources (e.g., servers, host bus adapters, network adapters, switches, laptops, desktops, game consoles, storage devices, and the like) and software resources (e.g., versions of operating systems, applications, hypervisors, firmware, and the like). Provisioning the resources to execute a workload on a cloud environment involves selecting a set of resources that are compatible with each other.

### BRIEF DESCRIPTION OF THE DRAWINGS

FIG. 1 is a diagram illustrating a cloud environment system that supports Interoperability-as-a-Service (“InteropaaS”), according to an example.

FIG. 2 is an interoperability support matrix that may be stored in an interoperability support matrix driver, according to an example.

FIG. 3 is a flowchart illustrating a method for obtaining interoperability support matrixes from resources, according to an example.

FIG. 4 is a diagram illustrating a data structure for storing an interoperability support matrix in an interoperability support matrix repository, according to an example.

FIG. 5 is a flowchart illustrating a method for generating a recommendation of interoperable products, according to an example.

FIG. 6 is a flowchart illustrating a method for generating a resource set recommendation, according to an example.

FIG. 7 is a block diagram illustrating a computer device, in accordance with an example.

### DETAILED DESCRIPTION

Examples discussed herein may be applied to determine interoperability of resources within a cloud environment. One approach to determine interoperability between resources in the cloud environment may involve an administrator of the cloud environment manually recording or referring to, for each resource supporting the workload, the resources that are compatible with other resources. To assist in this, a vendor may publish an interoperability matrix with their products. Then, the administrator may consult these interoperability matrixes before deploying a workload to the data center.

However, this manual approach to determine interoperability between resources can be tedious, time consuming, and error prone. Additionally, this manual approach can also be time-consuming for the administrator of the data center as it may take administrative knowledge of different technologies and domains (e.g., the administrative knowledge of interoperability between hardware/software vendor specific configurations). Further, such manual interoperability matrixes can change whenever new versions of resources are released by vendors, exacerbating the above problems.

Rather than use manual approaches for interoperability matrixes, examples discussed herein may use a new service offered by a cloud environment referred to herein as InteropaaS (short for “Interoperability-as-a-Service”). Some implementations of an InteropaaS may expose interfaces which are consumed by a services of cloud environment (e.g., an orchestration service) to ensure interoperability of one or more resources before provisioning a new workload. An InteropaaS can internally gather interoperability information from: (a) resources which may reside within a driver associated with the resource; (b) interoperability information stored in system images (such as, for example, qcow2, iso, and the like) of the cloud environment; (c) a vendor website of respective hardware or software; a vender supplied storage device (e.g., compact disk (“CD”)-read only memory (“ROM”), flash drive, external drive, thumb drive; or any other suitable source. A system image may specify the software resources installed on a hardware system.

Examples discussed in the foregoing utilize a format for publishing an interoperability matrix according to a format referred to herein as open interoperability format (OIF). A vendor can publish an interoperability matrix in an OIF file located in a driver for the resource. Also the OIF file can be included in software packages or system images.

These and other example are discussed in the foregoing.

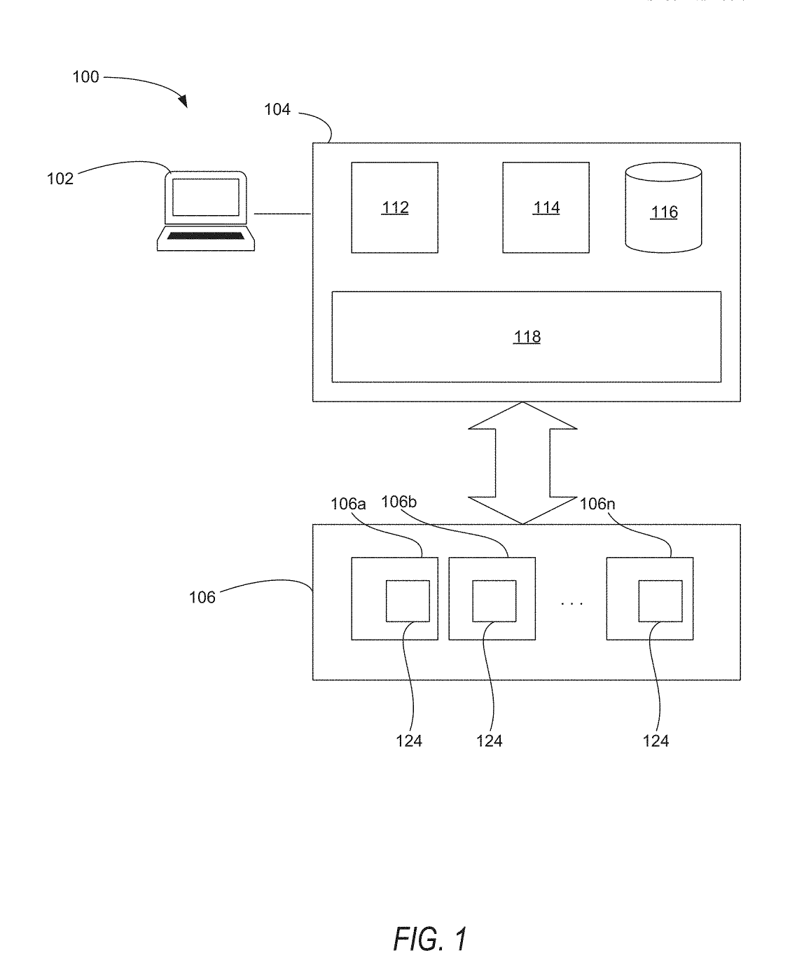

FIG. 1 is a diagram illustrating a cloud environment system 100 that supports InteropaaS, according to an example. For example, the system 100 may include an administration device 102, a data center operating system (OS) 104, and a set of resources 106. The administration device 102, the data center operating system (OS) 104, and the set of resources 106 may be communicatively coupled through, for example, a network.

The administration device 102 may be a computer system (e.g., one or more computer devices, such as desktops, laptops, networking devices, tablets, mobile phones, set-top boxes, and the like) that is configured to send a workload deployment request to the data center OS 104. The administration device 102 may be operated by an administrator. The workload deployment request may be data or logic that requests for a product configuration to be deployed on the set of resource 106. For example, the workload deployment request may specify a product name (e.g., ProductName=Product1), a vender name (e.g., Vendor Name=Hypervisorware), a product type (e.g., Product Type=Hypervisor), a product version (e.g., Product Version=8.0) or any other suitable field.

The cloud operating system (OS) 104 may be a distributed service executing on a computer system (e.g., one or more computer devices, such as desktops, laptops, network devices, tablets, mobile phones, set-top boxes, and the like) that operates within cloud computing and virtualization environments. A cloud OS system 104 may manage the operation, execution and processes of virtual machines, virtual servers, containers, micro-services, and virtual infrastructure, as well as the back-end hardware and software resources of the resources 106. As one example, the cloud OS system 104 may provision a workload deployment request onto the resources 106.

FIG. 1 shows that the cloud OS 104 may include an orchestration module 112, an InteropaaS module 114, interoperability data repository 116, and cloud services 118. The orchestration module 112 may be a computer-implemented module that can configure multiple resources together to execute a given workload. Further, the orchestration module 112 may connect and automate workload when applicable to deliver a defined service.

The InteropaaS module 114 may be a service implemented by a computer system for providing interoperability data for resources 106. Further, in some examples, the InteropaaS module 114 may gather interoperability information from the resources. The operation of the InteropaaS module 114 is discussed in greater detail below.

The interoperability data repository 116 may be a data store for collecting, accessing, and otherwise accessing data derived from interoperability support matrix obtained from interoperability support matrix drivers of the resources. In one example, as is explained below, the data stored in the interoperability data repository 116 may allow the InteropaaS module 114 to search for and identify resources that can interoperate with a given resource.

FIG. 1 shows that the cloud OS 104 may also include cloud services 118. Cloud services 118 may be a collection of services implemented by a computer system for providing services across the infrastructure provided by the resources 106. By way of example and not limitation, cloud services may include a cloud fabric controller (e.g., the NOVA service that is part of OPENSTACK), an object storage service (e.g., the SWIFT service that is part of OPENSTACK), a block storage service (e.g., the CINDER service that is part of OPENSTACK), a service for managing a network and Internet Protocol (IP) addresses (e.g., the NEUTRON service that is part of OPENSTACK), a backup service (e.g., the RAKSHA service that is part of OPENSTACK), an imaging service (e.g., the GLANCE service that is part of OPENSTACK, which provides discovery, registration, and delivery services for disk and server images), and the like.

With continued reference to FIG. 1, the system 100 includes the resources 106 (individually, resources 106a-n). A resource may be a physical or logical entity in cloud environment that can be used to execute a workload, once deployed thereon. By way of example and not limitation, a resource may be a server, a storage array, a network switch, a host bus adapter card, a network adapter, a logical network, a subnet, a network port, a gateway, a router, an operating system, an application, hypervisor, firmware, or the like.

A resource may include an interoperability support matrix driver 124. An interoperability support matrix driver may expose an interface for querying an interoperability support matrix for the respective resource. An interoperability support matrix may be data and/or logic stored by the resource that specifies configurations of resources that can interoperate with the resource. In some cases, the interoperability support matrixes of the resources 106 may be expressed in an open interoperability format (“OIF”).

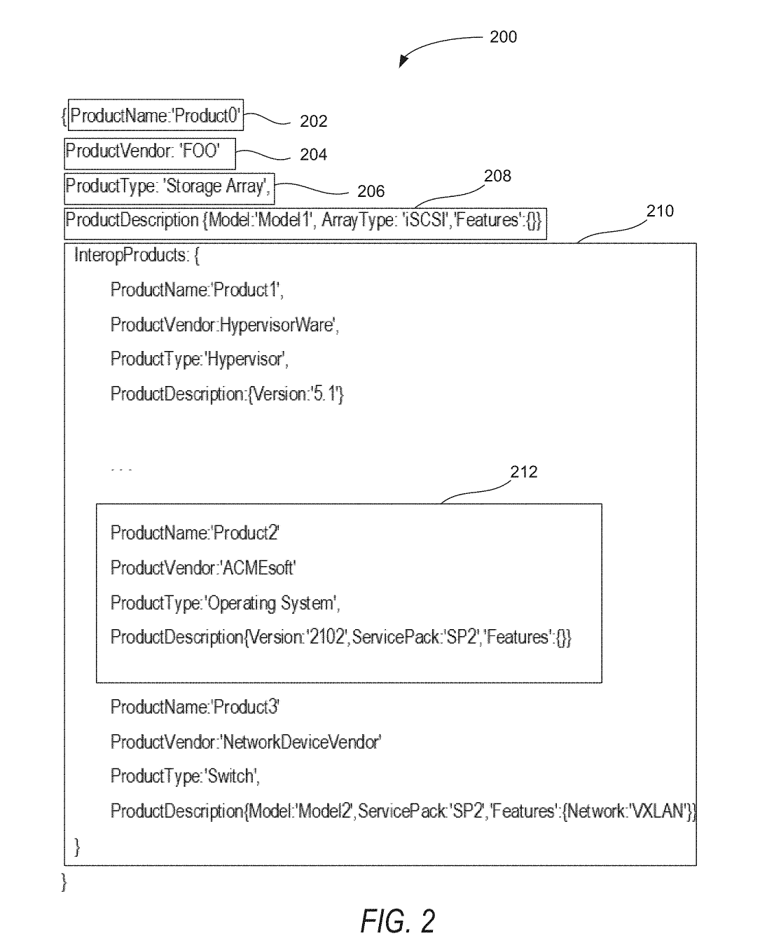

FIG. 2 is an interoperability support matrix 200 that may be stored in an interoperability support matrix driver, according to an example. The interoperability support matrix 200 may include fields to characterize a given resource, such as a resource name field 202 to specify a product name, a vender identifier field 204 to specify a name associated with the vendor of the resource, a product type field 206 to identify the type of the resource, a resource description field 208 to list attributes of the resource (which may, in some cases, be dependent on the resource type), and an interoperability section 210 that may include a list of resources that can interoperate with the resource represented by the interoperability support matrix 200. For example, the interoperability section 210 may include multiple interoperability resource sub-fields that each characterize an interoperable resource. For example, the multiple interoperability resource sub-field 212 specifies that the resource represented by the interoperability support matrix 200 (the ‘3PAR’ product) may interoperate with a ‘PRODUCT2’ ‘OPERATING SYSTEM,’ as may be offered by ‘ACMESOFT,’ as may be detailed by the multiple interoperability resource sub-field 212 through fields that specify a product name, resource type, and vender, respectively.

Examples of operational aspects of a cloud environment system that offering an InteropaaS are now discussed in greater detail.

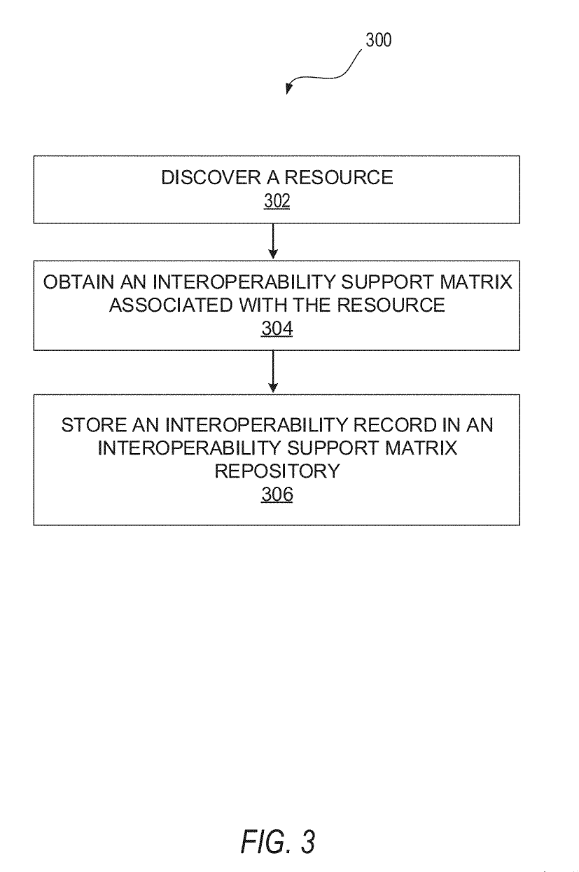

FIG. 3 is a flowchart illustrating a method 300 for obtaining interoperability support matrixes from resources, according to an example. The method 300 may be performed by the modules, components, systems shown in FIG. 1, and, accordingly, is described herein merely by way of reference thereto. For example, in some cases, the method 300 may be performed by a cloud OS or, more precisely, in some cases, an InteropaaS module. It will be appreciated that the method 300 may, however, be performed on any suitable hardware.

At operation 302, the method 300 may begin when the cloud OS discovers a resource in the cloud environment. In some cases, the discovery may occur when the resource is added to the cloud environment. Further, in some cases, the cloud OS can assign a unique identifier to the resource, such as a universally unique identifier (“UUID”). A dedicated cloud service may monitor for addition events. In other cases, the action of discovering addition events may be distributed across different cloud service, such as a cloud fabric controller (e.g., NOVA) for some hardware resources and an imaging service (e.g., GLANCE) for software resources.

At operation 304, responsive to discovering the resource, the cloud OS may obtain an interoperability support matrix from the discovered resource. The technique for obtaining an interoperability support matrix may differ according to the type of resource. For example, a hardware resource may include an interoperability support matrix in the interoperability support matrix driver released with the hardware resource. In this way, some example of the interoperability support matrix driver not only provides an interface for interacting with the hardware resource but the interoperability support matrix driver can also be used as an interface for providing an interoperability support matrix. Thus, to illustrate an example of operation 304 with respect to hardware resources, the InteropaaS service may be configured to listen for the discovery of a new hardware resource and, responsive to the discovery, the InteropaaS may fetch the interoperability support matrix (which may be in the form of an OIF file) from the driver of the respective hardware resource.

With regard to software resources, the cloud OS may upload software modules as images and store these images in an image repository, e.g., a GLANCE. In this context, an interoperability support matrix (possibly in OIF format) for a software resource may be stored in an image uploaded to the image repository. Accordingly, the InteropaaS module may listen for image upload events and, upon detecting an image upload event, the InteropaaS module may mount the respective image and fetch the interoperability support matrix (e.g., an OIF file) present inside the image.

In some cases, the interoperability support matrix (e.g., an OIF file) may be located on a website, which may be maintained or otherwise hosted by the vendor or a third-party. In such cases, the InteropaaS module may obtain the interoperability support matrix via a link (e.g., a uniform resource locator (“URL”)) embedded in the interoperability support matrix driver of the resource. Alternatively, the InteropaaS module may obtain the interoperability support matrix via a storage device supplied by an administrator.

At operation 306, the cloud OS (e.g., the InteropaaS module) stores an interoperability record in the interoperability support matrix repository. The interoperability record may specify that the resource can interoperate with the resource listed in the interoperability support matrix. In some examples, the interoperability record may be indexed according to a resource identifier (e.g., an UUID) assigned to the resource, as may occur at operation 302. The interoperability record persisted in the interoperability support matrix repository can be used by the InteropaaS module to recommend possible sets of resources for provisioning of a work load.

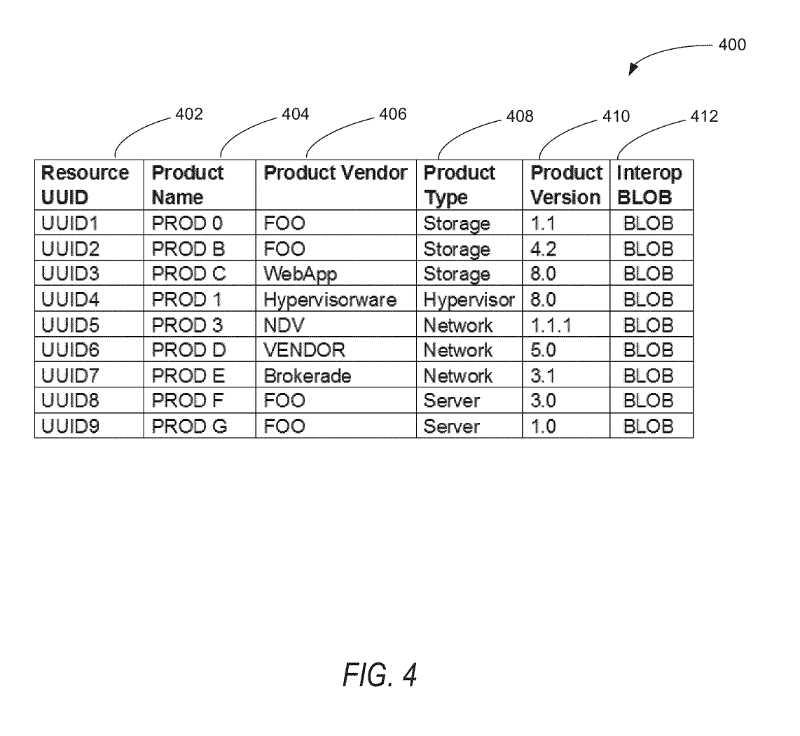

FIG. 4 is a diagram illustrating a data structure for storing an interoperability support matrix 400 in an interoperability support matrix repository, according to an example. The interoperability support matrix 400 may be represented as a table where the rows represent different resources and the columns represent properties of a resource. A row of the interoperability support matrix 400 may represent an interoperability record. Column 402 may specify a resource identifier assigned to a resource when the resource is added to the set of resources. Column 404 may specify a product name for the resource. Column 406 may specify a vendor for the resource. Column 408 may specify a product type for the resource. Column 408 may specify a resource type for the resource. Column 410 may specify a version number for the resource. Column 412 may specify an interoperability blob. The interoperability blob may specify resources that may interoperate with a given resource. The interoperability blob may be derived from data contained in the interoperability section of an interoperability support matrix stored in an interoperability support matrix driver. Further, an interoperability blob may be formatted in any number of data formats, such as JavaScript Object Notation (“JSON”), Extensible Markup Language (“XML”), or any other suitable format.

Aspects of method for determining interoperability between resources are now discussed. In some examples, a deployment tree may be used to determine interoperability between resources. A deployment tree as used herein may refer to data and/or logic that represents an order of types of resources that are to be searched to find a set of interoperable products. For example, the following deployment tree represents a deployment of a workload involving an Application resource type:
Application(s)→Operating System→Hypervisor→Server→Network→Storage

The above deployment tree denotes an order as: finding an interoperable Operating System resource, then an interoperable Hypervisor resource, then an interoperable Server resource, then an interoperable Network resource, and finally an interoperable Storage resource.

The InteropaaS engine can refer to a deployment tree to determine what type of resource types are involved for provisioning a given workload deployment request. For example to deploy an Operating System, Hypervisor, Server, Network, Storage resource types are involved. It is up to the orchestration module to use all resource types or subset of resource types for provisioning a workload. For example, the orchestration module can choose to deploy an image directly on Server without using a Hypervisor resource type in the scenario that a Hypervisor resource type is not represented in the deployment tree.

Table 1 illustrates, by way of examples and not limitation, additional deployment trees that may be passed to the InteropaaS module:

TABLE 1

| Deployment Tree | Description |
|---|---|
| Application(s) →Operating | Application installed on bare |
| System →Server →Network→ | metal Servers, where the |
| Storage | Server is connected to |
| | Storage through a Network |
| Application(s) →Operating | Application installed on bare |
| System →Server →Storage | metal Servers, Server is |
| | directly connected to Storage |
| | (e.g., Direct Attached Storage) |
| Application(s) →Operating | Application installed on bare |
| System →Hypervisor →Server | metal Servers with internal |
| | storage |
| Application →Container →OS→ | Application installed on a |
| Server →Switch →Storage | container, such as |
| | DOCKER ™ |

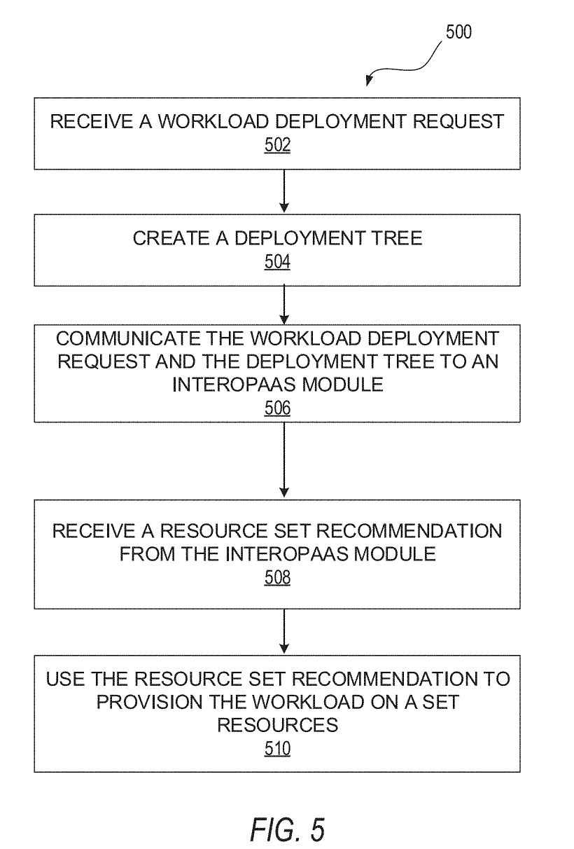

FIG. 5 is a flowchart illustrating a method 500 for generating a recommendation of interoperable products, according to an example. The method 500 may be performed by the modules, components, systems shown in FIG. 1, and, accordingly, is described herein merely by way of reference thereto. For example, in some cases, the method 500 may be performed by a cloud OS or, more precisely, in some cases, an orchestration module. It will be appreciated that the method 500 may, however, be performed on any suitable hardware.

The method 500 may begin at operation 502 when a workload deployment request is received by a cloud OS (e.g., an orchestration module, such as HEAT, IRONIC, NOVA, or the like). The workload deployment request may be sent by an administrator device. A workload deployment request may include any combination of a product name, a vendor name, a product type, a product version, and any other suitable field. For example a workload deployment request (WRQ) may include the following fields (as name, value pairs): ProductName=Product1, Vendor Name=Hypervisorware, Product Type=Hypervisor, Product Version=8.0.

At operation 504, the orchestration module may then create a deployment tree of resource types to be used for provisioning the workload represented by the workload deployment request WRQ. Let us denote the Deployment Tree as DTchosen. As discussed above, a deployment tree may specify an ordering of resource types that are to interoperate with each other as part of a deployment. For example, the DTchosen may represent “Hypervisor→Server→Network→Storage” to indicate the workload is to be deployed on bare metal Servers, where the Server is connected to Storage through a Network.

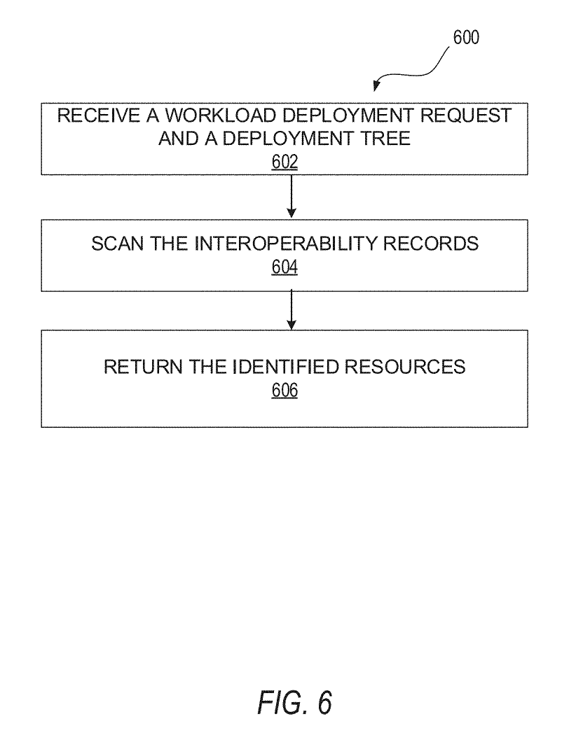

At operation 506, the orchestration module communicates the workload deployment request WRQ and the deployment tree DTchosen to the InteropaaS module. Communicating the workload deployment request WRQ and the deployment tree DTchosen to InteropaaS module may be part of a request to the InteropaaS module to generate a resource set recommendation. Once the InteropaaS module receives a request to generate a resource set recommendation, the InteropaaS module may generate the resource set recommendation. The operations of generating a resource set recommendation is discussed in greater detail below with reference to FIG. 6. However, to clarify the discussion of the method 500, a resource set recommendation may include a set of resources for each resource type listed by the deployment tree.

At operation 508, upon receiving a resource set recommendation from the InteropaaS module, the orchestration module may use the resource set recommendation to provision the workload on the resources. For example, the resource set recommendation may include a set of resource type recommendations. In turn each, resource type recommendation may include products that interoperate with the products listed in the other resource type recommendations. For example, the resource set recommendation may be a data set, such as:

Res_{recommended}={Server_{recommended}, Network_{recommended}, Storage_{recommended}}

Where Resrecommended is the resource set recommendation. Serverrecommended may be a resource type recommendation that specifies products of Server type that interoperate with the workload deployment request. Networkrecommended may be a resource type recommendation that specifies products of Network type that interoperate with the workload deployment request. Storagerecommended may be a resource type recommendation that specifies products of Storage type that interoperate with the workload deployment request. The Serverrecommended, the Networkrecommended, and the Storagerecommended may specify a product using a resource identifier.

The orchestration module uses Resrecommended for provisioning the workload deployment request WRQ. The resource scheduling module within the orchestration module can consider Resrecommended for provisioning in conjunction with other factors, such as utilization, geographic location, tenant, zone, and any other aspect.

The operations of generating a resource set recommendation is now discussed in greater detail. For example, FIG. 6 is a flowchart illustrating a method 600 for generating a resource set recommendation, according to an example. The method 600 may be performed by the modules, components, systems shown in FIG. 1, and, accordingly, is described herein merely by way of reference thereto. For example, in some cases, the method 600 may be performed by a cloud OS or, more precisely, in some cases, an InteropaaS module. It will be appreciated that the method 600 may, however, be performed on any suitable hardware.

The method 600 may begin at operation 602 when the InteropaaS module receives a workload deployment request (e.g., WRQ) and a deployment tree (DTchosen) from the orchestration module. As discussed above, the workload deployment request may include a set of properties that characterize a workload, such as a product name, product type, version number, vender name, and the like. Similarly, the deployment tree may be data or logic that specifies an ordering of resource types that are to interoperate with each other as part of the deployment specified by the workload deployment request.

At operation 604, based on the resource type specified in the workload deployment request and the set of resource types specified in the deployment tree, the InteropaaS module scans the interoperability records persisted in the interoperability support matrix repository to identify the resources that interoperate with the workload specified in the workload deployment request and the ordered list of resource types.

At operation 606, the InteropaaS module returns the identified the resources that interoperate with the workload to the orchestration module of the cloud OS.

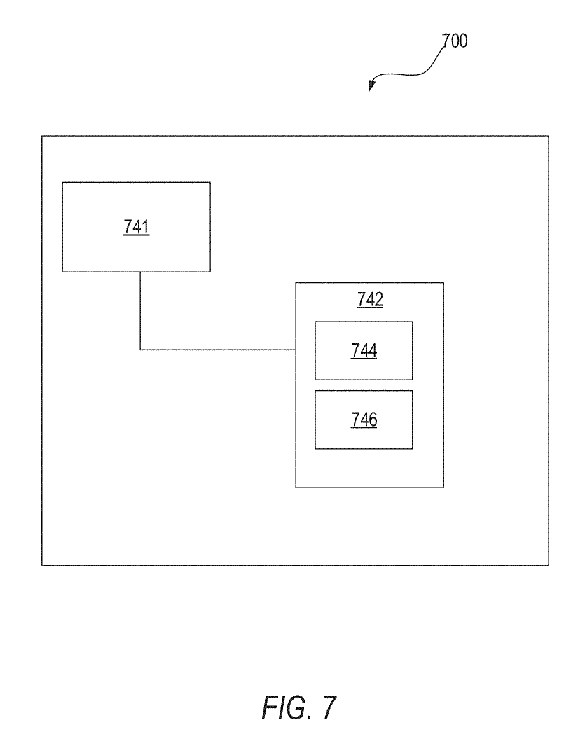

FIG. 7 is a block diagram illustrating a computer device 700, in accordance with an example. The computer device 700 may include a processor 741 and a computer-readable storage device 742. The processor 741 may be a device suitable to read and execute processor executable instructions, such as a CPU, or an integrated circuit configured to perform a configured function. The processor executable instructions may cause the processor 741 to implement techniques described herein.

The processor 741 shown in FIG. 7 is coupled to the computer-readable storage device 742. The computer-readable storage device 742 may contain thereon a set of instructions, which when executed by the processor 741, cause the processor 741 to execute the techniques described herein. For example, the computer-readable storage device 742 may include interoperability matrix building instructions 744 and interoperability recommendation instructions 746.

For example, in one aspect, execution of the instructions 744, whole or in part, may cause the processor 741 to discover a resource in the cloud environment. The instructions can also cause the processor to, responsive to discovering the resource, obtain an interoperability support matrix associated with the resource. The interoperability support matrix can specify another resource that interoperates with the resource. Also, the instructions can also cause the processor to store an interoperability record in an interoperability support matrix repository. The interoperability record specifying that the another resource interoperates with the resource.

With regard to instructions 746, execution of the instructions 746, whole or in part, may cause the processor 741 to receive a workload deployment request and a deployment tree from an orchestration module of a cloud OS. The workload deployment request may include properties that characterize a workload. The deployment tree may specify an ordered list of resource types that are to interoperate with each other as part of a deployment of the workload. Based on the properties included in the workload deployment request and the ordered list of resource types specified in the deployment tree, the instructions can cause the processor to scan the interoperability records in an interoperability support matrix repository to identify resources that interoperate with the workload specified in the workload deployment request and the ordered list of resource types. Then the instructions can cause the processor to return the identified resources to the orchestration module of the cloud OS.

What is claimed is:

1. A method comprising:
receiving, by at least one processor, a workload deployment request, the workload requesting a workload to be deployed in a cloud environment;
creating, by the at least one processor, a deployment tree that specifies an ordered list of resource types to be used in provisioning a workload represented by the workload deployment request;
communicating, by the at least one processor, the workload deployment request and the deployment tree to an Interoperability-as-a-Service (“InteropaaS”) module of the cloud operating system (OS);
receiving, by the at least one processor, a resource set recommendation from the InteropaaS module; and
using, by the at least one processor, the resource set recommendation to provision the workload on a set resources.

2. The method of claim 1, wherein the workload deployment request includes a product name, a vendor name, product version, and a resource type.

3. The method of claim 2, wherein the resource set recommendation specifies a set of resources for each of the resource types listed by the deployment tree that interoperate with each other.

4. The method of claim 1, wherein provisioning the workload includes configuring resources according to resources selected from the set of resources specified by the resource set recommendation.

5. The method of claim 1, wherein the resource types include at least one of a server, a storage array, a network switch, a host bus adapter card, a network adapter, a logical network, a subnet, a network port, a gateway, a router, an operating system, a hypervisor, an application, or firmware.

6. A device comprising:
a processor; and
a machine-readable storage device comprising instructions that provide an Interoperability-as-a-Service (“InteropaaS”), the instructions when executed, cause the processor to:
discover a resource in a cloud environment;
responsive to discovering the resource, obtain an interoperability support matrix associated with the resource, the interoperability support matrix specifying another resource that interoperates with the resource; and
store an interoperability record in an interoperability support matrix repository, the interoperability record specifying that the another resource interoperates with the resource.

7. The device of claim 6, wherein the instructions further cause the processor to discover the resource when the resource is added to the cloud environment.

8. The method of claim 7, wherein the interoperability support matrix includes an interoperability section that lists additional resources that interoperate with the resource.

9. The method of claim 8, wherein the interoperability record specifies that the another resource interoperates with the resource based on the another resource being listed in the additional resources of the interoperability section.

10. The method of claim 6, wherein the instructions further cause the processor to obtain the interoperability support matrix based on fetching the interoperability support matrix from a driver corresponding to the resource.

11. The method of claim 6, wherein the instructions further cause the processor to obtain the interoperability support matrix based on fetching the interoperability support matrix from a system image.

12. A machine-readable storage device comprising instructions that provide an Interoperability-as-a-Service (“InteropaaS”), the instruction, when executed, cause a processor to:
receive a workload deployment request and a deployment tree from an orchestration module of a cloud operating system (“OS”) of a cloud environment, the workload deployment request including properties that characterize a workload, the deployment tree specifying an ordered list of resource types that are to interoperate with each other as part of a deployment of the workload;
based on the properties included in the workload deployment request and the ordered list of resource types specified in the deployment tree, scan the interoperability records in an interoperability support matrix repository to identify resources that interoperate with the workload specified in the workload deployment request and the ordered list of resource types; and
return the identified resources to the orchestration module of the cloud OS.

13. The machine-readable storage device of claim 12, wherein the ordered list of resource types include at least one of a server, a storage array, a network switch, a host bus adapter card, a network adapter, a logical network, a subnet, a network port, a gateway, a router, an operating system, a hypervisor, an application, or firmware.

14. The machine-readable storage device of claim 12, wherein the instructions, when executed, further cause the processor to identify the resources that interoperate with the workload specified in the workload deployment request and the ordered list of resource types based on:
identifying an interoperability record matching the workload; and
identifying, within a interoperability blob, interoperability resource sub-fields corresponding to the resources.

15. The machine-readable storage device of claim 13, wherein the workload deployment request includes a product name and a vender name, and identifying the interoperability record matching the workload involves matching the product name and vender name with fields in the interoperability record.
